(19) United States
(12) Patent Application Publication
(10) Pub. No.: US 2025/0316699 A1
(43) Pub. Date: Oct. 9, 2025

(54) COMPOSITE CATHODE FOR ALL-SOLID-STATE BATTERY INCLUDING TWO TYPES OF CONDUCTIVE MATERIALS

(71) Applicants: Hyundai Motor Company, Seoul (KR); Kia Corporation, Seoul (KR); Industry-University Cooperation Foundation Hanyang University, Seoul (KR)

(72) Inventors: Wo Dum Jung, Seoul (KR); Sang Heon Lee, Seongnam (KR); Sang Soo Lee, Suwon (KR); So Young Kim, Jeongeup (KR); Ho Cheol Shin, Seoul (KR); Jae Young Kim, Suwon (KR); Hong Seok Min, Yongin (KR); Geun Hyeong Shin, Hwaseong (KR); Jong Won Lee, Seoul (KR); Jong Hyeok Yun, Gwangju (KR); Min Hyeong Cho, Seoul (KR)

(21) Appl. No.: 18/910,836

(22) Filed: Oct. 9, 2024

(30) Foreign Application Priority Data
Apr. 9, 2024 (KR) 10-2024-0047869

(51) Int. Cl. H01M 4/62; H01M 4/02; H01M 4/131; H01M 10/0562

(52) U.S. Cl. CPC H01M 4/625; H01M 4/131; H01M 10/0562; H01M 2004/021; H01M 2004/028; H01M 2300/008

(57) ABSTRACT

A composite cathode for an all-solid-state battery including two types of conductive materials. Electron transfer resistance, ion transfer resistance, and interfacial resistance of the composite cathode are reduced in a balanced manner using a composite conductive material including a spherical conductive material and a linear conductive material in a predetermined weight ratio. This configuration improves the initial charge/discharge efficiency, reversible capacity, and output characteristics of the all-solid-state battery.

### CROSS-REFERENCE TO RELATED APPLICATION

This application claims, under 35 U.S.C. § 119(a), the benefit of Korean Patent Application No. 10-2024-0047869, filed on Apr. 9, 2024, the entire contents of which are incorporated herein by reference.

### BACKGROUND

### Technical Field

The present disclosure relates to a composite cathode for an all-solid-state battery, including two types of conductive materials. This invention aims to reduce electron transfer resistance, ion transfer resistance, and interfacial resistance of the composite cathode in a balanced manner. By using a composite conductive material that includes a spherical conductive material and a linear conductive material in a predetermined weight ratio, the initial charge/discharge efficiency, reversible capacity, and output characteristics of the all-solid-state battery are improved.

### Background

An all-solid-state battery is configured to include a cathode, an anode, and a solid electrolyte layer. Thereamong, the cathode and the anode have a composite configuration composed of an active material, a solid electrolyte, a conductive material, a binder, etc. Unlike general lithium-ion batteries, all-solid-state batteries include a solid electrolyte component that is responsible for conducting lithium ions, so the volume ratio of a material contributing to conducting electrons is reduced. As a result, electronic conductivity of the cathode and the anode may decrease. To solve this problem, research is underway to improve electronic conductivity of the cathode and the anode.

In general, a conductive material is added to improve electronic conductivity of the electrode, especially the cathode. Electronic conductivity is determined depending on unique characteristics of the conductive material, such as type, morphology, etc., but from the perspective of the cathode structure, the morphology of the conductive material is an important factor in determining electronic conductivity of the cathode. Unlike lithium-ion batteries, all-solid-state batteries require careful determination of the appropriate amount of the conductive material, considering the high reactivity between the solid electrolyte and the conductive material.

Generally, a carbon-based conductive material is used as a conductive material. However, although a carbon-based conductive material helps the movement of electrons in the composite cathode, it may hinder movement of lithium ions and accelerate side reaction with the sulfide-based solid electrolyte. Accordingly, when the amount of the carbon-based conductive material is equal to or greater than a certain level, internal resistance of the composite cathode may increase, deteriorating performance of the all-solid-state battery. Therefore, the amount of the conductive material included in the composite cathode of an all-solid-state battery must be limited to a level at which a sufficient conductive network may be formed but internal resistance does not increase significantly.

### SUMMARY OF THE DISCLOSURE

The present disclosure has been made keeping in mind the problems encountered in the related art, and is intended to provide a composite cathode including a cathode active material, a solid electrolyte, and a conductive material mixed in a predetermined ratio, thus improving electronic conductivity and ionic conductivity in a balanced manner, particularly reducing electrical resistance, ionic resistance, and interfacial resistance of the composite cathode in a balanced manner.

In particular, the present disclosure is intended to provide a composite cathode using a composite conductive material including a spherical conductive material and a linear conductive material in a predetermined ratio, to form an improved conductive network in the cathode active material and inhibiting side reaction with the solid electrolyte.

The objects of the present disclosure are not limited to the foregoing. The objects of the present disclosure will be able to be clearly understood through the following description and to be realized by the means described in the claims and combinations thereof.

An embodiment of the present disclosure provides a composite cathode for an all-solid-state battery including a cathode active material, a solid electrolyte, and a composite conductive material, in which the composite conductive material that includes both a spherical conductive material and a linear conductive material.

In one embodiment, the composite cathode may include 1.5 wt % to 2.5 wt % of the composite conductive material based on the total weight thereof.

In one embodiment, the composite cathode may include 2 wt % of the composite conductive material based on the total weight thereof.

Also, the composite cathode may include 0.5 wt % to 1.5 wt % of the spherical conductive material based on the total weight thereof.

Moreover, the composite cathode may include 0.5 wt % to 1.5 wt % of the linear conductive material based on the total weight thereof.

In one embodiment, the spherical conductive material may include any one selected from the group consisting of carbon black, Ketjen black, acetylene black, and combinations thereof. In one aspect, a spherical conductive material may appear spherical (or comparatively spherical versus a linear conductive material) under a scanning electron microscope. In a further aspect, lengths of opposing dimensions (e.g. x and y axis) of a spherical conductive material may differ by less than 50, 40, 30, 20, 10, 5, 3,2 or 1 percent.

In one embodiment, the linear conductive material may include any one selected from the group consisting of carbon nanotubes (CNTs), carbon nanofiber (CNF), vapor grown carbon fiber (VGCF), and combinations thereof. In one aspect, a linear conductive material may appear linear (or comparatively linear versus a spherical conductive material) under a scanning electron microscope. In a further aspect, lengths of opposing dimensions (e.g. x and y axis) of a linear conductive material may differ by more than 30, 40, 50, 60, 70, 80, 90, 100 or 200 percent.

In aspects, in a particular composite conductive material, a linear conductive material may have lengths of opposing dimensions (e.g. x and y axis) that are 5, 10, 20, 30, 40, 50, 60, 70, 80, 90 or 100 percent or more than the lengths of opposing dimensions (e.g. x and y axis) of the spherical conductive material of the same compositive conductive material.

In one embodiment, a weight ratio of the spherical conductive material to the linear conductive material may be 3:1 to 1:3.

In one embodiment, a weight ratio of the spherical conductive material to the linear conductive material may be 1:1 to 1:3.

In one embodiment, an average particle diameter of the spherical conductive material may be 5 nm to less than 30 nm, and an average length of the linear conductive material may be 6 μm to 10 μm.

In one embodiment, the ratio of a specific surface area of the spherical conductive material relative to a specific surface area of the linear conductive material may be 3-6.

In one embodiment, the ionic resistance of the composite cathode may be 4,000 Ω·cm or less, and electrical resistance of the composite cathode may be 400 Ω·cm or less.

In one embodiment, the solid electrolyte may include a sulfide-based solid electrolyte having an argyrodite crystal structure.

Also provided is an all-solid-state battery comprising the composite cathode.

Also provided is a composite cathode comprising: a cathode active material, a solid electrolyte, and a composite conductive material, wherein the composite conductive material comprises a spherical conductive material and a linear conductive material, and wherein a weight ratio of the spherical conductive material to the linear conductive material is 1:1 to 1:3.

In one embodiment, the composite cathode may include 1.5 wt % to 2.5 wt % of the composite conductive material based on a total weight of the composite cathode.

In one embodiment, the composite cathode may include 0.5 wt % to 1.5 wt % of the spherical conductive material based on a total weight of the composite cathode.

In one embodiment, the composite cathode may include 0.5 wt % to 1.5 wt % of the linear conductive material based on a total weight of the composite cathode.

Also provided is an all-solid-state battery comprising the composite cathode.

As discussed, the method and system suitably include use of a controller or processer.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a composite conductive material according to the present disclosure;

FIG. 2 shows a scanning electron microscope (SEM) image of the composite conductive material according to the present disclosure;

FIG. 3 shows an SEM image of a spherical conductive material;

FIG. 4 shows an SEM image of a linear conductive material;

FIG. 5 shows the potential of all-solid-state batteries according to Comparative Examples 1, 3, and 5 during charging and discharging;

FIG. 6 shows the potential of all-solid-state batteries according to Comparative Examples 2, 4, and 6 during charging and discharging;

FIG. 7 shows the potential of all-solid-state batteries according to Examples 1 and 2 during charging and discharging;

FIG. 8 shows a comparison of charge/discharge curves of the all-solid-state batteries according to Example 1 and Comparative Examples 3 and 4;

FIG. 9 shows a comparison of charge/discharge curves of the all-solid-state batteries according to Example 1 and Comparative Examples 7 and 8;

FIG. 10 shows results of measurement of discharge capacity depending on power density of the all-solid-state batteries according to Comparative Examples 1, 3, and 5;

FIG. 11 shows results of measurement of discharge capacity depending on power density of the all-solid-state batteries according to Comparative Examples 2, 4, and 6;

FIG. 12 shows results of measurement of discharge capacity depending on power density of the all-solid-state batteries according to Examples 1 and 2;

FIG. 13 shows results of measurement of discharge capacity depending on power density of the all-solid-state batteries according to Examples 1 and 2 and Comparative Examples 3 and 4; and

FIG. 14 shows results of measurement of discharge capacity depending on power density of the all-solid-state batteries according to Examples 1 and 2 and Comparative Examples 7 and 8.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

The present disclosure pertains to a composite cathode for an all-solid-state battery. According to an embodiment of the present disclosure, the composite cathode may include a cathode active material, a solid electrolyte, and a composite conductive material.

The cathode active material is configured to supply lithium ions. The cathode active material is not particularly limited, but may be, for example, an oxide active material or a sulfide active material.

Examples of the oxide active material may include a rocksalt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rocksalt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni, and Zn, 0<x+y<2), lithium titanate such as Li₄Ti₅O₁₂, and the like.

Examples of the sulfide active material may include copper sulfide, iron sulfide, cobalt sulfide, nickel sulfide, and similar compounds.

The solid electrolyte facilitates the movement of lithium ions in the cathode. The solid electrolyte may include an oxide-based solid electrolyte or a sulfide-based solid electrolyte. Here, it is preferable to use a sulfide-based solid electrolyte due to its high lithium ion conductivity.

Examples of the sulfide-based solid electrolyte may include Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS2-P₂S₅-LiI, Li₂S-B₂S₃, Li₂S-P₂S₅-ZmSn (in which m and n are positive numbers, and Z is any one selected from among Ge, Zn, and Ga), Li₂S-GeS₂, Li₂S-SiS₂-Li₃PO₄, Li₂S-SiS₂-LiₓMO_{y} (in which x and y are positive numbers, and M is any one selected from among P, Si, Ge, B, Al, Ga, and In), Li₁₀GeP₂S₁₂, and the like.

Preferably, the sulfide-based solid electrolyte includes a sulfide-based solid electrolyte having an argyrodite crystal structure. The sulfide-based solid electrolyte having an argyrodite crystal structure is a solid electrolyte that has the same crystal structure as argyrodite ore with a composition of Ag₈GeS₆ and exhibits lithium ion conductivity. The sulfide-based solid electrolyte having an argyrodite crystal structure according to the present disclosure may include, for example, Li₇PS₆, Li₆PS₅X (X=Cl, Br, I), etc.

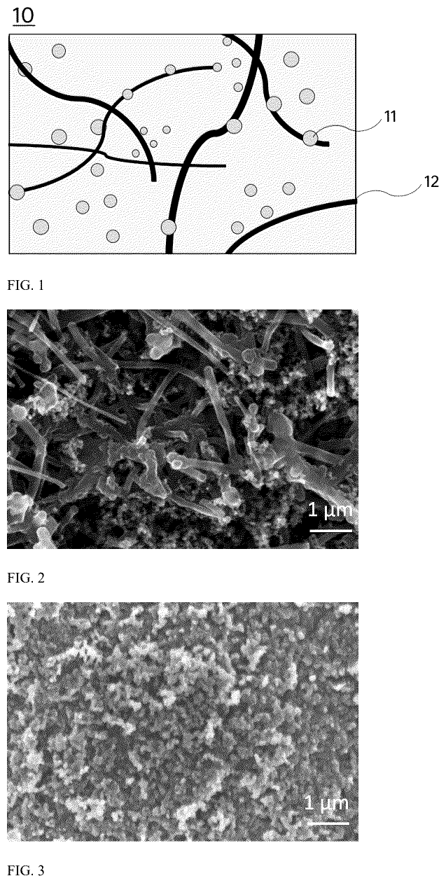

FIG. 1 shows a composite conductive material according to the present disclosure. Referring to FIG. 1, the composite conductive material 10 of the composite cathode according to the present disclosure may include a spherical conductive material 11 and a linear conductive material 12.

The composite conductive material according to the present disclosure is able to effectively form electron and ion movement paths in the composite cathode for an all-solid-state battery by combining a zero-dimensional spherical conductive material 11 and a one-dimensional linear conductive material 12. Specifically, when a zero-dimensional, nanoscale spherical conductive material 11 is present in the composite cathode of an all-solid-state battery, an improved electron conductive network may be formed in the cathode active material. Also, the presence of a one-dimensional, microscale linear conductive material 12 facilitates the movement of lithium ions between the cathode active material and the solid electrolyte, while suppressing side reactions with the sulfide-based solid electrolyte due to its low specific surface area.

In one embodiment, the spherical conductive material 11 may include any one selected from the group consisting of carbon black, Ketjen black, acetylene black, and combinations thereof. Also, the linear conductive material 12 may include any one selected from the group consisting of carbon nanotubes (CNTs), carbon nanofiber (CNF), vapor grown carbon fiber (VGCF), and combinations thereof.

Meanwhile, the size of the spherical conductive material 11 is not particularly limited, but may be nano-sized. Preferably, the average particle diameter of the spherical conductive material 11 is 5 nm to less than 30 nm. Also, the diameter and length of the linear conductive material 12 are not particularly limited, but may be micro-sized. Preferably, the average length of the linear conductive material 12 is 6 μm to 10 μm, and the diameter thereof is 100 nm to 300 nm.

If the average particle diameter of the spherical conductive material 11 is less than 5 nm, it is too small to disperse effectively in the cathode active material to form an electron movement path. Conversely, if the average particle diameter thereof exceeds 30 nm, it may be too large, leading to poor dispersion in the composite cathode.

If the length of the linear conductive material 12 is less than 6 μm, the specific surface area may increase due to the small size and the movement of lithium ions may be hindered, whereas if the length thereof exceeds 10 μm, the conductive effect may decrease due to self-aggregation.

In one embodiment, the composite cathode may include 1.5 wt % to 2.5 wt % of the composite conductive material based on the total weight thereof. Preferably, the amount of the composite conductive material is about 2 wt %.

When the amount of the composite conductive material is 1.5 wt % to 2.5 wt %, ionic resistance, electrical resistance, and interfacial resistance of the composite cathode may be reduced in a balanced manner. Accordingly, the initial charge capacity, initial discharge capacity, and initial efficiency of the all-solid-state battery including the composite cathode may be improved, along with its output characteristics. This improvement in electrochemical properties may be maximized when the amount of the composite conductive material is 2 wt %.

If the amount of the composite conductive material is less than 1.5 wt %, the amount thereof may be excessively small and the conductive effect may decrease. On the other hand, if the amount of the composite conductive material exceeds 2.5 wt %, the energy density of the all-solid-state battery including the composite cathode may decrease.

Also, the composite cathode may include 0.5 wt % to 1.5 wt % of the spherical conductive material 11 based on the total weight thereof. Furthermore, the composite cathode may include 0.5 wt % to 1.5 wt % of the linear conductive material 12 based on the total weight thereof.

When the amount of each of the spherical conductive material 11 and the linear conductive material 12 falls in the range of 0.5 wt % to 1.5 wt %, ionic resistance, electrical resistance, and interfacial resistance of the composite cathode may be reduced in a balanced manner. Accordingly, the initial charge capacity, initial discharge capacity, and initial efficiency of the all-solid-state battery, including the composite cathode may be improved, and along with its output characteristics.

If the amount of the spherical conductive material 11 or the linear conductive material 12 is less than 0.5 wt %, it may be difficult to form an electron conductive network in the cathode active material.

In one embodiment, the weight ratio of the spherical conductive material 11 to the linear conductive material 12 may be 1:1 to 1:3.

When the weight ratio of the spherical conductive material 11 to the linear conductive material 12 falls in the range of 1:1 to 1:3, ionic resistance, electrical resistance, and interfacial resistance of the composite cathode may be reduced in a balanced manner. Accordingly, initial charge capacity, initial discharge capacity, and initial efficiency of the all-solid-state battery including the composite cathode may be improved, and output characteristics thereof may also be improved.

In one embodiment, the ratio of the specific surface area of the spherical conductive material 11 relative to the specific surface area of the linear conductive material 12 may be 3 to 6. In the composite conductive material of the composite cathode according to the present disclosure, the spherical conductive material 11 has a large specific surface area, so that an electron movement path with the cathode active material may be formed uniformly. Also, since the linear conductive material 12 has a small specific surface area, side reaction with the sulfide-based solid electrolyte may be suppressed.

Therefore, if the ratio of the specific surface area of the spherical conductive material 11 to the specific surface area of the linear conductive material 12 is less than 3, electron transfer resistance or ion transfer resistance may increase, or side reactions between the composite conductive material and the sulfide-based solid electrolyte may increase.

On the other hand, if the ratio of the specific surface area of the spherical conductive material 11 relative to the specific surface area of the linear conductive material 12 exceeds 6, the spherical conductive material 11 may self-aggregate or the linear conductive material 12 may interfere with movement of lithium ions.

Also, the ionic resistance of the composite cathode including the composite conductive material according to the present disclosure may be 4,000 Ω·cm or less, and the electrical resistance thereof may be 400 Ω·cm or less. Here, ionic resistance may refer to ion transfer resistance, and electrical resistance may refer to electron transfer resistance. In this way, when both the ionic resistance and the electrical resistance of the composite cathode fall in the above numerical ranges, the purpose of the present disclosure of improving electronic conductivity and ionic conductivity of the composite cathode in a balanced manner may be achieved.

The all-solid-state battery including the composite cathode may include a composite cathode 10, an anode, and a solid electrolyte layer interposed between the composite cathode 10 and the anode.

According to an embodiment of the anode of the present disclosure, the anode may include an anode current collector and an anode active material, and may further include a binder and a solid electrolyte, as necessary.

The anode current collector may include a material that does not react with lithium. Specifically, the anode current collector may include at least one selected from the group consisting of nickel (Ni), copper (Cu), stainless steel, and combinations thereof.

The thickness of the anode current collector is not particularly limited and may be, for example, 1 μm to 500 μm.

The anode active material may be a compound capable of reversibly storing and releasing lithium. For example, the anode active material may include any one selected from the group consisting of a carbon-based active material, a silicon-based active material, a metal active material, lithium titanium oxide, and combinations thereof.

The carbon active material may be graphite such as mesocarbon microbeads (MCMB) and highly oriented pyrolytic graphite (HOPG), or amorphous carbon such as hard carbon and soft carbon.

The metal active material may be In, Al, Si, Sn, or an alloy containing at least one thereof.

The solid electrolyte is responsible for movement of lithium ions in the anode. The solid electrolyte may include an oxide-based solid electrolyte or a sulfide-based solid electrolyte, with a preference for using a sulfide-based solid electrolyte due to its high lithium ion conductivity.

Examples of the sulfide-based solid electrolyte may include Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS2-P₂S₅-LiI, Li₂S-B₂S₃, Li₂S-P₂S₅-ZmSn (in which m and n are positive numbers, and Z is any one selected from among Ge, Zn, and Ga), Li₂S-GeS₂, Li₂S-SiS₂-Li₃PO₄, Li₂S-SiS₂-LiₓMO_{y} (in which x and y are positive numbers, and M is any one selected from among P, Si, Ge, B, Al, Ga, and In), Li₁₀GeP₂S₁₂, and the like. Preferably, the sulfide-based solid electrolyte is a sulfide-based solid electrolyte having an argyrodite crystal structure.

As such, the sulfide-based solid electrolyte included in the anode may be the same as or different from that included in the composite cathode.

According to another embodiment of the anode of the present disclosure, the anode may include an anode current collector and lithium metal or a lithium metal alloy.

The lithium metal alloy may include an alloy of lithium and a metal or metalloid capable of alloying with lithium. The metal or metalloid capable of alloying with lithium may include Si, Sn, Al, Ge, Pb, Bi, Sb, or the like.

According to still another embodiment of the anode of the present disclosure, the anode may include an anode current collector and a predetermined layer assisting storage of lithium, but may not include an anode active material and a component that plays a similar role. In other words, an anodeless type may be provided.

When charging the all-solid-state battery, lithium ions that move from the composite cathode are precipitated and stored in the form of lithium metal between the predetermined layer and the anode current collector. The predetermined layer may include amorphous carbon and a metal capable of forming an alloy with lithium.

The amorphous carbon may include at least one selected from the group consisting of furnace black, acetylene black, Ketjen black, graphene, and combinations thereof.

The metal may include at least one selected from the group consisting of gold (Au), platinum (Pt), palladium (Pd), silicon (Si), silver (Ag), aluminum (Al), bismuth (Bi), tin (Sn), zinc (Zn), and combinations thereof.

The solid electrolyte layer facilitates the movement of lithium ions between the composite cathode and the anode. The solid electrolyte layer may include a solid electrolyte. Specifically, the solid electrolyte may include an oxide-based solid electrolyte or a sulfide-based solid electrolyte. Here, it is preferable to use a sulfide-based solid electrolyte due to its high lithium ion conductivity.

Examples of the sulfide-based solid electrolyte may include Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS2-P₂S₅-LiI, Li₂S-B₂S₃, Li₂S-P₂S₅-ZmSn (in which m and n are positive numbers, and Z is any one selected from among Ge, Zn, and Ga), Li₂S-GeS₂, Li₂S-SiS₂-Li₃PO₄, Li₂S-SiS₂-LiₓMO_{y} (in which x and y are positive numbers, and M is any one selected from among P, Si, Ge, B, Al, Ga, and In), Li₁₀GeP₂S₁₂, and the like.

Preferably, the sulfide-based solid electrolyte has an argyrodite crystal structure. This solid electrolyte is substantially the same as the sulfide-based solid electrolyte having an argyrodite crystal structure included in the composite cathode, and thus a description thereof will be omitted.

Meanwhile, the solid electrolyte in the solid electrolyte layer may be the same as or different from that included in the composite cathode or the anode.

The solid electrolyte layer may further include a binder. The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), etc.

A better understanding of the present disclosure may be obtained through the following examples and comparative examples. However, these examples are not to be construed as limiting the technical spirit of the present disclosure.

### Preparation Example 1—0.5 wt % of Spherical Conductive Material+1.5 wt % of Linear Conductive Material

Carbon black (Super-C65, Timical) was prepared as a spherical conductive material, and vapor grown carbon fiber (VGCF, Showa Denko) was prepared as a linear conductive material. Specifically, carbon black with an average particle diameter of about 10 nm and a BET specific surface area of about 59.1 m²/g was prepared, and vapor grown carbon fiber with a length of about 7 μm and a BET specific surface area of about 12.3 m²/g was prepared. FIG. 2 is an SEM image of the prepared spherical conductive material, and FIG. 3 is an SEM image of the prepared linear conductive material.

A composite conductive material was synthesized by mixing the spherical conductive material and the linear conductive material in a weight ratio of 25:75. FIG. 1 shows an SEM image of the synthesized composite conductive material.

Thereafter, a cathode slurry was prepared by adding the composite conductive material, a sulfide-based solid electrolyte (Li₆PS₅Cl) having an argyrodite crystal structure, and NCM 811 (LiNi_{0.8}Co_{0.1}Mn_{0.1}O₂) as a cathode active material to a solvent having low reactivity with sulfur and mixing the same. The slurry was applied onto an aluminum thin film, followed by drying to remove the solvent, thereby forming a composite cathode formed on a cathode current collector.

Based on results of analysis of the composition of the composite cathode according to Preparation Example 1, the weight ratio of the cathode active material to the composite conductive material to the solid electrolyte was 73:2:25, and respective amounts of the spherical conductive material and the linear conductive material were measured to be 0.5 wt % and 1.5 wt %.

### Preparation Example 2—1.0 wt % of Spherical Conductive Material+1.0 wt % of Linear Conductive Material

A composite cathode was manufactured in the same manner as in Preparation Example 1, with the exception that the spherical conductive material and the linear conductive material were mixed in a weight ratio of 50:50 in the process of manufacturing the composite cathode, and thus the amount of each of the spherical conductive material and the linear conductive material in the composite cathode was set to 1.0 wt %.

### Comparative Preparation Example 1—1.0 wt % of Spherical Conductive Material

A composite cathode was manufactured in the same manner as in Preparation Example 1, with the exception that the spherical conductive material (Super C65) was used alone as a conductive material in the process of manufacturing the composite cathode, and thus the amount of the spherical conductive material in the composite cathode was set to 1.0 wt %.

### Comparative Preparation Example 2—1.0 wt % of Linear Conductive Material

A composite cathode was manufactured in the same manner as in Preparation Example 1, with the exception that the linear conductive material (VGCF) was used alone as a conductive material in the process of manufacturing the composite cathode, and thus the amount of the linear conductive material in the composite cathode was set to 1.0 wt %.

### Comparative Preparation Example 3—2.0 wt % of Spherical Conductive Material

A composite cathode was manufactured in the same manner as in Comparative Preparation Example 1, with the exception that the amount of the spherical conductive material in the composite cathode was set to 2.0 wt %.

### Comparative Preparation Example 4—2.0 wt % of Linear Conductive Material

A composite cathode was manufactured in the same manner as in Comparative Preparation Example 2, with the exception that the amount of the linear conductive material in the composite cathode was set to 2.0 wt %.

### Comparative Preparation Example 5—3.0 wt % of Spherical Conductive Material

A composite cathode was manufactured in the same manner as in Comparative Preparation Example 1, with the exception that the amount of the spherical conductive material in the composite cathode was set to 3.0 wt %.

### Comparative Preparation Example 6—3.0 wt % of Linear Conductive Material

A composite cathode was manufactured in the same manner as in Comparative Preparation Example 2, with the exception that the amount of the linear conductive material in the composite cathode was set to 3.0 wt %.

### Comparative Preparation Example 7—0.4 wt % of spherical conductive material+1.6 wt % of Linear Conductive Material

A composite cathode was manufactured in the same manner as in Preparation Example 1, with the exception that the spherical conductive material and the linear conductive material were mixed in a weight ratio of 20:80 in the process of manufacturing the composite cathode, and thus respective amounts of the spherical conductive material and the linear conductive material in the composite cathode were set to 0.4 wt % and 1.6 wt %.

### Comparative Preparation Example 8—1.6 wt % of Spherical Conductive Material+0.4 wt % of Linear Conductive Material

A composite cathode was manufactured in the same manner as in Preparation Example 1, with the exception that the spherical conductive material and the linear conductive material were mixed in a weight ratio of 80:20 in the process of manufacturing the composite cathode, and thus respective amounts of the spherical conductive material and the linear conductive material in the composite cathode were set to 1.6 wt % and 0.4 wt %.

### Test Example 1—Confirmation of Properties of Composite Cathode

In order to confirm electrochemical properties of the synthesized composite cathodes, ionic resistance, electrical resistance, interfacial resistance, and porosity were measured. The results thereof are shown in Table 1 below.

TABLE 1

| | | Ionic | Electrical | Interfacial | Po- |
|---|---|---|---|---|---|
| | Conductive | resistance | resistance | resistance | rosity |
| Classification | material | (Ω · cm) | (Ω · cm) | (Ω · cm³) | (%) |
| Preparation | Super C65 + | 3560 | 210 | 0.17 | 14.5 |
| Example 1 | VGCF | | | | |
| | (0.5 wt % + | | | | |
| | 1.5 wt %) | | | | |
| Preparation | Super C65 + | 3819 | 350 | 0.25 | 14.5 |
| Example 2 | VGCF | | | | |
| | (1.0 wt % + | | | | |
| | 1.0 wt %) | | | | |
| Comparative | Super C65 (1 | 3409 | 1003 | 0.10 | 14.2 |
| Preparation | wt %) | | | | |
| Example 1 | | | | | |
| Comparative | VGCF | 2853 | 1150 | 0.09 | 14.6 |
| Preparation | (1 wt %) | | | | |
| Example 2 | | | | | |
| Comparative | Super C65 (2 | 6652 | 352 | 0.27 | 14.2 |
| Preparation | wt %) | | | | |
| Example 3 | | | | | |
| Comparative | VGCF | 4332 | 432 | 0.26 | 14.9 |
| Preparation | (2 wt %) | | | | |
| Example 4 | | | | | |
| Comparative | Super C65 (3 | 7926 | 143 | 0.54 | 14.1 |
| Preparation | wt %) | | | | |
| Example 5 | | | | | |
| Comparative | VGCF | 6810 | 231 | 0.49 | 15.1 |
| Preparation | (3 wt %) | | | | |
| Example 6 | | | | | |
| Comparative | Super C65 + | 4282 | 445 | 0.26 | 14.5 |
| Preparation | VGCF | | | | |
| Example 7 | (0.4 wt % + | | | | |
| | 1.6 wt %) | | | | |
| Comparative | Super C65 + | 6848 | 366 | 0.28 | 14.4 |
| Preparation | VGCF | | | | |
| Example 8 | (1.6 wt % + | | | | |
| | 0.4 wt %) | | | | |

According to Table 1, in Comparative Preparation Examples 1 to 6 using a single conductive material, as the amount of the conductive material increased, the electrical resistance of the composite cathode decreased and the ionic resistance and interfacial resistance thereof increased. Therefore, it can be found that a sufficient electron conductive network is formed by the conductive material, and the internal resistance loss of the battery is small when using 2 wt % of the single conductive material, as seen in Comparative Preparation Examples 3 and 4.

As such, in Preparation Examples 1 and 2 in which the composite conductive material was included in a total amount of 2 wt % in the composite cathode and carbon black as the spherical conductive material and vapor grown carbon fiber as the linear conductive material were mixed in weight ratios of 25:75 and 50:50, the porosity was lower than Comparative Preparation Examples 2, 4, and 6 in which microscale vapor grown fiber was used as the single conductive material.

In addition, Preparation Examples 1 and 2 had low ionic resistance and electrical resistance in a balanced manner. Also, interfacial resistance was confirmed to be quite low compared to Comparative Preparation Examples 7 and 8 including 2 wt % of the composite conductive material, as in the present disclosure.

The reduction in ionic resistance, electrical resistance, and interfacial resistance of the composite cathode according to the present disclosure is deemed to be due to effective formation of electron and ion movement paths by mixing the spherical conductive material and the linear conductive material in a predetermined weight ratio and also due to a decrease in contact area between the active material and the conductive material. Moreover, among Preparation Examples 1 and 2, Preparation Example 1, in which the spherical conductive material and the linear conductive material were mixed in a weight ratio of 25:75, exhibited the lowest ionic resistance, electrical resistance, and interfacial resistance of the composite cathode.

On the other hand, in Comparative Preparation Examples 7 and 8 in which the spherical conductive material and the linear conductive material were mixed in weight ratios of 20:80 and 80:20, respectively, ionic resistance, electrical resistance, and interfacial resistance were not reduced in a balanced manner as in the present disclosure. This confirms that simply using a composite conductive material does not achieve the purpose of the present disclosure.

### Test Example 2—Confirmation of Electrochemical Properties of All-Solid-State Battery Manufactured Using Composite Cathode

In order to confirm the extent to which the electrochemical properties of the all-solid-state battery are improved by the composite cathode manufactured above, a battery was manufactured as follows.

Specifically, a sulfide-based solid electrolyte (Li₆PS₅Cl) having an argyrodite crystal structure in powder form was placed in a mold with a diameter of 13Φ and pressed at a pressure of 100 MPa for about 1 minute, forming a solid electrolyte layer. Each of the composite cathodes from Preparation Examples 1 and 2 and Comparative Preparation Examples 1 to 8 was placed on one side of the solid electrolyte layer. A laminate of lithium metal on a copper thin film was placed as an anode counter electrode on the other side, and a predetermined pressure was applied thereto, thereby manufacturing a coin cell.

Below, the coin cells manufactured using the composite cathodes according to Preparation Examples 1 and 2 are referred to as Examples 1 and 2, respectively, and the coin cells manufactured using the composite cathodes according to Comparative Preparation Examples 1 to 8 are referred to as Comparative Examples 1 to 8, respectively.

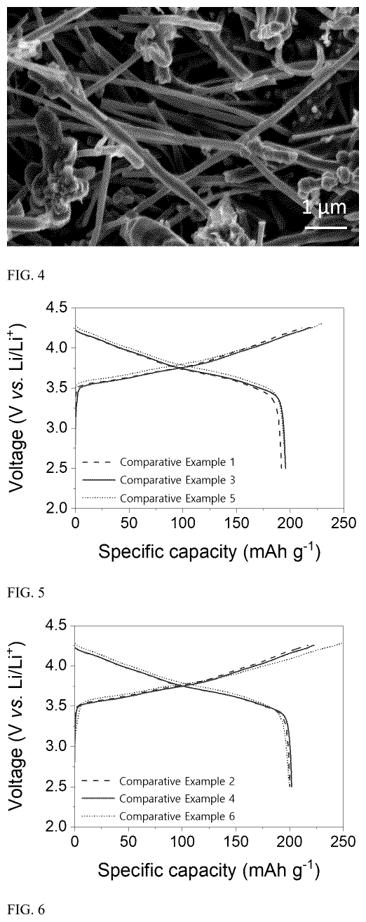

The coin cells thus manufactured were initially charged and discharged in the range of 2.5 V to 4.25 V at a current density of 0.1C at 30° C. During charging and discharging, the initial charge and discharge capacities of Examples 1 and 2 and Comparative Examples 1 to 8 were measured, and the initial efficiencies were calculated from these values and are listed in Table 2 below. In addition, the results of comparing the charge/discharge curves of the all-solid-state batteries under different manufacturing conditions are shown in FIGS. 5 to 9.

TABLE 2

| | | Initial | Initial | |
|---|---|---|---|---|
| | | charge | discharge | Initial |
| | Conductive | capacity | capacity | efficiency |
| Classification | material | (mAh/g) | (mAh/g) | (%) |
| Example 1 | Super C65 + | 224.9 | 205.3 | 91.3 |
| | VGCF | | | |
| | (0.5 wt % + | | | |
| | 1.5 wt %) | | | |
| Example 2 | Super C65 + | 221.1 | 201.6 | 91.2 |
| | VGCF | | | |
| | (1.0 wt % + | | | |
| | 1.0 wt %) | | | |
| Comparative | Super C65 (1 | 210.9 | 192.0 | 91.0 |
| Example 1 | wt %) | | | |
| Comparative | VGCF | 217.2 | 200.4 | 92.2 |
| Example 2 | (1 wt %) | | | |
| Comparative | Super C65 (2 | 219.5 | 195.8 | 89.2 |
| Example 3 | wt %) | | | |
| Comparative | VGCF | 223.1 | 202.1 | 90.6 |
| Example 4 | (2 wt %) | | | |
| Comparative | Super C65 (3 | 230.4 | 195.3 | 84.7 |
| Example 5 | wt %) | | | |
| Comparative | VGCF | 252.9 | 199.5 | 80.0 |
| Example 6 | (3 wt %) | | | |
| Comparative | Super C65 + | 220.5 | 200.2 | 90.8 |
| Example 7 | VGCF | | | |
| | (0.4 wt % + | | | |
| | 1.6 wt %) | | | |
| Comparative | Super C65 + | 221.2 | 197.9 | 89.5 |
| Example 8 | VGCF | | | |
| | (1.6 wt % + | | | |
| | 0.4 wt %) | | | |

FIG. 5 shows the potential of the all-solid-state batteries according to Comparative Examples 1, 3, and 5 in which the composite cathode included carbon black, which is a spherical conductive material, in varying amounts as a single conductive material. According to FIG. 5 and Table 2, as the amount of the spherical conductive material increased, the initial charge capacity increased, but the initial efficiency decreased. Also, the initial discharge capacity exhibited a maximum value at 2 wt %.

FIG. 6 shows the potential of the all-solid-state batteries according to Comparative Examples 2, 4, and 6 in which the composite cathode included vapor grown carbon fiber, which is a linear conductive material, in different amounts as a single conductive material. According to FIG. 6 and Table 2, as the amount of the linear conductive material increased, the initial charge capacity increased, but the initial efficiency decreased. Also, the initial discharge capacity exhibited a maximum value at 2 wt %.

According to Table 2 and FIGS. 5 and 6, in Comparative Examples 1 to 6 in which the composite cathode included the single conductive material in different amounts, Comparative Examples 3 and 4, with 2 wt % of the conductive material, exhibited the best initial discharge capacity and initial efficiency.

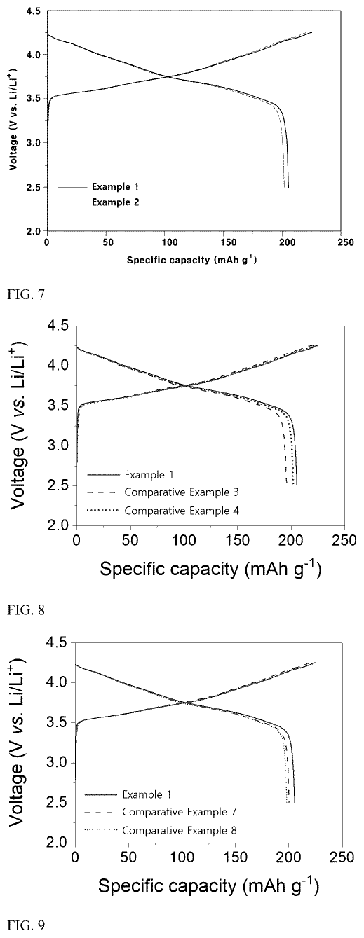

FIG. 7 shows the potential of the all-solid-state batteries according to Examples 1 and 2 in which the amount of the composite conductive material in the composite cathode was set to 2 wt % and the spherical conductive material and the linear conductive material were used in different ratios. According to FIG. 7 and Table 2, the initial charge capacity, initial discharge capacity, and initial efficiency of Example 1 were superior to those of Example 2. Among Examples 1 and 2, Example 1, in which spherical carbon black and linear vapor grown carbon fiber were mixed in a weight ratio of 25:75, exhibited the greatest initial discharge capacity and initial efficiency.

FIG. 8 shows a comparison of charge and discharge characteristics of Comparative Examples 3 and 4, which exhibited the best performance when using the single conductive material, and Example 1, which exhibited the best performance when using the composite conductive material. Referring to FIG. 8 and Table 2, Example 1 exhibited superior performance in all of initial charge capacity, initial discharge capacity, and initial efficiency compared to Comparative Examples 3 and 4.

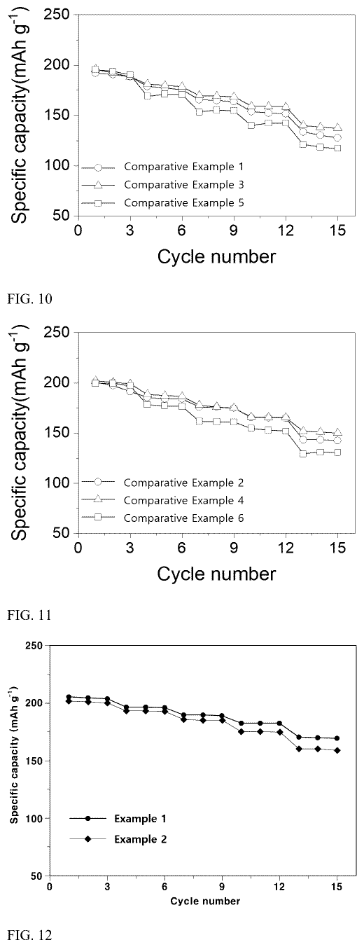

FIG. 9 compares the charge/discharge curves of the all-solid-state batteries according to Example 1 and Comparative Examples 7 and 8 to determine a difference in performance depending on the weight ratio between the spherical conductive material and the linear conductive material when using the composite conductive material. Referring to FIG. 9 and Table 2, in Comparative Examples 7 and 8 in which the composite conductive material was used but the weight ratio of the spherical conductive material to the linear conductive material fell outside the ratio of 75:25 to 25:75 (3:1 to 1:3), preferably 50:50 to 25:75 (1:1 to 1:3), there was no significant increase in initial discharge capacity and initial efficiency.

### Test Example 4—Confirmation of Output Characteristics of All-Solid-State Battery Manufactured Using Composite Cathode

In order to confirm the output characteristics of the all-solid-state batteries according to Examples and Comparative Examples manufactured in Test Example 3, the charge and discharge cycle was repeated at different current densities. Specifically, charging and discharging were repeated three times each in the range of 2.5 V to 4.25 V at current densities of 0.1 C, 0.2 C, 0.33 C, 0.5 C, and 1 C at 30° C.

During charging and discharging, the discharge capacities of Examples 1 and 2 and Comparative Examples 1 to 8 were measured, and the average values thereof were calculated and are listed in Table 3 below. In addition, FIGS. 10 to 14 show the results of comparing the output characteristic curves of the all-solid-state batteries under different manufacturing conditions.

TABLE 3

| | | 0.1C | 0.2C | 0.33C | 0.5C | 1C |
|---|---|---|---|---|---|---|
| | Conductive | (mAh/ | (mAh/ | (mAh/ | (mAh/ | (mAh/ |
| Classification | material | g) | g) | g) | g) | g) |
| Example 1 | Super C65 + | 205.3 | 196.7 | 189.7 | 182.7 | 170.6 |
| | VGCF | | | | | |
| | (0.5 wt % + | | | | | |
| | 1.5 wt %) | | | | | |
| Example 2 | Super C65 + | 201.6 | 193.5 | 185.8 | 175.5 | 160.2 |
| | VGCF | | | | | |
| | (1.0 wt % + | | | | | |
| | 1.0 wt %) | | | | | |
| Comparative | Super C65 | 192.0 | 178.7 | 165.7 | 153.7 | 133.6 |
| Example 1 | (1 wt %) | | | | | |
| Comparative | VGCF | 200.4 | 185.4 | 176.0 | 165.6 | 143.3 |
| Example 2 | (1 wt %) | | | | | |
| Comparative | Super C65 | 195.8 | 181.2 | 169.7 | 159.2 | 140.0 |
| Example 3 | (2 wt %) | | | | | |
| Comparative | VGCF | 202.1 | 188.6 | 178.0 | 166.2 | 151.9 |
| Example 4 | (2 wt %) | | | | | |
| Comparative | Super C65 | 195.3 | 169.1 | 153.4 | 139.9 | 121.0 |
| Example 5 | (3 wt %) | | | | | |
| Comparative | VGCF | 199.5 | 178.4 | 161.6 | 154.8 | 129.3 |
| Example 6 | (3 wt %) | | | | | |
| Comparative | Super C65 + | 200.2 | 190.6 | 180.0 | 169.4 | 154.7 |
| Example 7 | VGCF | | | | | |
| | (0.4 wt % + | | | | | |
| | 1.6 wt %) | | | | | |
| Comparative | Super C65 + | 197.9 | 190.0 | 179.5 | 167.4 | 152.4 |
| Example 8 | VGCF | | | | | |
| | (1.6 wt % + | | | | | |
| | 0.4 wt %) | | | | | |

FIG. 10 shows the discharge capacity depending on the power density of the all-solid-state batteries according to Comparative Examples 1, 3, and 5 in which the composite cathode included carbon black, which is a spherical conductive material, in different amounts as a single conductive material. According to FIG. 10 and Table 3, in all Comparative Examples, the discharge capacity tended to decrease with an increase in the power density, and in particular, when the amount of the spherical conductive material was 2 wt %, the best output characteristics were exhibited.

FIG. 11 shows the discharge capacity depending on the power density of the all-solid-state batteries according to Comparative Examples 2, 4, and 6 in which the composite cathode included vapor grown carbon fiber, which is a linear conductive material, in different amounts as a single conductive material. According to FIG. 11 and Table 3, in all Comparative Examples, the discharge capacity decreased with an increase in the power density, and in particular, when the amount of the linear conductive material was 2 wt %, the best output characteristics were exhibited.

According to Table 3 and FIGS. 10 and 11, in Comparative Examples 1 to 6 in which the composite cathode included the single conductive material in different amounts, Comparative Examples 3 and 4, in which the amount of the conductive material in the composite cathode was 2 wt %, exhibited the greatest output characteristics.

FIG. 12 shows the discharge capacity depending on the power density of the all-solid-state batteries according to Examples 1 and 2 in which the amount of the composite conductive material in the composite cathode was set to 2 wt % and the spherical conductive material and the linear conductive material were used in different ratios. According to FIG. 12 and Table 3, the output characteristics of Example 1 were superior to those of Example 2.

Among Examples 1 and 2, Example 1, in which spherical carbon black and linear vapor grown carbon fiber were mixed in a weight ratio of 25:75, exhibited the greatest output characteristics.

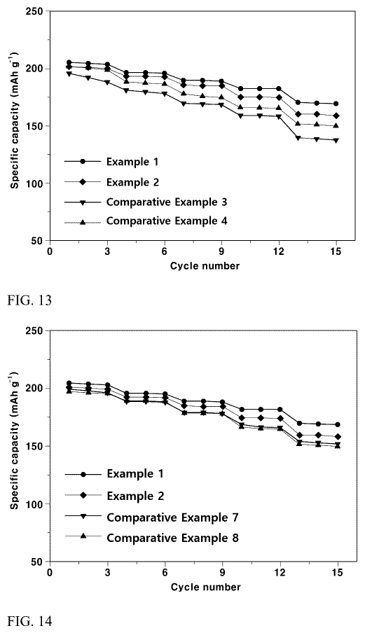

FIG. 13 shows a comparison of the discharge capacity depending on the power density of the all-solid-state batteries according to Comparative Examples 3 and 4, which exhibited the best performance when using the single conductive material, and Examples 1 and 2 using the composite conductive material. Referring to FIG. 13 and Table 3, all Examples exhibited better output characteristics than Comparative Examples 3 and 4.

FIG. 14 shows a comparison of the discharge capacity depending on the power density of the all-solid-state batteries according to Examples 1 and 2 and Comparative Examples 7 and 8 in order to determine a difference in performance depending on the weight ratio between the spherical conductive material and the linear conductive material when using the composite conductive material. As shown in FIG. 14 and Table 3, all Examples exhibited better output characteristics than Comparative Examples 7 and 8.

In Comparative Examples 7 and 8 in which the composite conductive material was used but the weight ratio of the spherical conductive material to the linear conductive material fell outside the range of 75:25 to 25:75 (3:1 to 1:3), preferably 50:50 to 25:75 (1:1 to 1:3), there was no significant improvement in output characteristics.

As is apparent from the above description, a composite cathode according to the present disclosure includes a composite conductive material including a spherical conductive material and a linear conductive material in a weight ratio of 1:1 to 1:3. This composition reduces electron transfer resistance, ion transfer resistance, and interfacial resistance in a balanced manner, thereby improving the initial charge/discharge efficiency, reversible capacity, and output characteristics of the all-solid-state battery.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A composite cathode for an all-solid-state battery, comprising:
a cathode active material, a solid electrolyte, and a composite conductive material,
wherein the composite conductive material comprises a spherical conductive material and a linear conductive material.

2. The composite cathode of claim 1, comprising 1.5 wt % to 2.5 wt % of the composite conductive material based on a total weight of the composite cathode.

3. The composite cathode of claim 1, comprising 2 wt % of the composite conductive material based on a total weight of the composite cathode.

4. The composite cathode of claim 1, comprising 0.5 wt % to 1.5 wt % of the spherical conductive material based on a total weight of the composite cathode.

5. The composite cathode of claim 1, comprising 0.5 wt % to 1.5 wt % of the linear conductive material based on a total weight of the composite cathode.

6. The composite cathode of claim 1, wherein the spherical conductive material comprises any one selected from the group consisting of carbon black, Ketjen black, acetylene black, and combinations thereof.

7. The composite cathode of claim 1, wherein the linear conductive material comprises any one selected from the group consisting of carbon nanotubes (CNTs), carbon nanofiber (CNF), vapor grown carbon fiber (VGCF), and combinations thereof.

8. The composite cathode of claim 1, wherein a weight ratio of the spherical conductive material to the linear conductive material is 3:1 to 1:3.

9. The composite cathode of claim 1, wherein a weight ratio of the spherical conductive material to the linear conductive material is 1:1 to 1:3.

10. The composite cathode of claim 1, wherein an average particle diameter of the spherical conductive material is 5 nm to less than 30 nm.

11. The composite cathode of claim 1, wherein an average length of the linear conductive material is 6 μm to 10 μm.

12. The composite cathode of claim 1, wherein a ratio of a specific surface area of the spherical conductive material relative to a specific surface area of the linear conductive material is 3 to 6.

13. The composite cathode of claim 1, wherein an ionic resistance of the composite cathode is 4,000 Ω·cm or less, and an electrical resistance of the composite cathode is 400 Ω·cm or less.

14. The composite cathode of claim 1, wherein the solid electrolyte comprises a sulfide-based solid electrolyte having an argyrodite crystal structure.

15. An all-solid-state battery comprising the composite cathode of claim 1.

16. A composite cathode comprising:
a cathode active material, a solid electrolyte, and a composite conductive material,
wherein the composite conductive material comprises a spherical conductive material and a linear conductive material, and
wherein a weight ratio of the spherical conductive material to the linear conductive material is 1:1 to 1:3.

17. The composite cathode of claim 16, comprising 1.5 wt % to 2.5 wt % of the composite conductive material based on a total weight of the composite cathode.

18. The composite cathode of claim 16, comprising 0.5 wt % to 1.5 wt % of the spherical conductive material based on a total weight of the composite cathode.

19. The composite cathode of claim 16, comprising 0.5 wt % to 1.5 wt % of the linear conductive material based on a total weight of the composite cathode.

20. An all-solid-state battery comprising the composite cathode of claim 16.
